(19) United States
(12) Patent Application Publication
(10) Pub. No.: US 2006/0283397 A1
(43) Pub. Date: Dec. 21, 2006

(54) Pet-food dish with a handle

(76) Inventor: Gerald Loeffelholz, Brooksville, FL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 11/445,557

(22) Filed: Jun. 2, 2006

Related U.S. Application Data
(60) Provisional application No. 60/690,858, filed on Jun. 15, 2005.

(51) Int. Cl. A01K 5/01

(52) U.S. Cl. 119/61.56

(57) ABSTRACT

Disclosed is a pet-food dish with a vertical handle. Any of a number of well known handle-attachment mechanisms are contemplated. While many of these mechanisms permanently fix the handle to the dish, some allow for detachment. The handle may be detached, for example, to allow the dish to easily fit in a dish washer. A single detachable handle can be used with a multitude of dishes, saving the cost of multiple handles when only one would typically be used at a time. Handles may be of different lengths and may telescope. At the “top,” or grasping end, of the handle, different surfaces are useful for different situations. While a simple surface suffices for many users, a large hook or a hole is useful for users who cannot easily grasp an unfeatured handle. A non-slip surface is useful in many situations, especially with those dishes used to dispense water.

### CROSS-REFERENCE TO RELATED APPLICATION

This application claims priority to U.S. Provisional Patent Application 60/690,858, “System for Manipulating a Pet-Food Dish,” which was filed on Jun. 15, 2005, and which is incorporated herein by reference in its entirety.

### FIELD OF THE INVENTION

The present invention is related generally to pet-food dishes, and, more particularly, to pet-food dishes with handles.

### BACKGROUND OF THE INVENTION

Dishes for holding and for dispensing pet food (in this context, “food” generally includes water) are normally placed on the floor so that the pets can access their food easily. To prevent the dish from spilling while the pet eats or when someone accidentally knocks against the dish, these dishes are often stabilized by making them quite heavy or by adding skid-resistant (e.g., rubber) feet to the bottom of the dish.

For many people, especially those whose back or legs have been rendered less flexible through age or disease, placing a dish heavily laden with food on the floor is not a trivial task. Even picking up an empty dish to refill it is not easy. The stabilizing mechanisms mentioned above exacerbate the difficulty of manipulating these dishes: they either add weight to an already unwieldy dish or, by their skid-resistant feet, resist the owner's attempts to move the dish around by pushing it with his hands or feet.

### BRIEF SUMMARY OF THE INVENTION

In view of the foregoing, the present invention provides a structure that eases the task of manipulating a pet-food dish, either laden or unladen. A vertical handle is affixed to the dish, and the user manipulates the dish using the handle. This handle obviates the need for reaching down so far to the ground. Via the handle, the dish is easily picked up for loading or for cleaning. Once loaded, the handle eases the task of positioning or repositioning the dish on the floor.

Any of a number of well known handle-attachment mechanisms are contemplated. Many of these mechanisms permanently fix the handle to the dish, for example by using a pressure fit, glue, or one-time snap fit. Other mechanisms allow for detachment such as by unscrewing or unclipping. The handle may be detached, for example, to allow the pet-food dish to easily fit in a dish washer. A single detachable handle can be used with a multitude of dishes, saving the cost of multiple handles when only one would typically be used at a time.

Different types of handles are contemplated. Handles may be of different lengths and may telescope. At the “top,” or grasping end, of the handle, different surfaces are useful for different situations. While a simple surface (i.e., like the end of a traditional mop handle) suffices for many users, a large hook or a hole is useful for users who cannot easily grasp an unfeatured handle. A non-slip surface is useful in many situations, especially with those dishes used to dispense water.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a perspective drawing with cut-away of a pet-food dish with a vertical handle;

FIGS. 2a, 2b, 2c, 2d, and 2e are partial section drawings of exemplary mechanisms for attaching the handle to the pet-food dish;

FIGS. 3a, 3b, and 3c are partial elevation drawings of exemplary grasping ends for the handle; and

FIGS. 4a and 4b are elevation drawings with partial sections of an exemplary telescoping handle in its closed and opened positions, respectively.

### DETAILED DESCRIPTION OF THE INVENTION

Turning to the drawings, wherein like reference numerals refer to like elements, the present invention is illustrated as being implemented in a suitable environment. The following description is based on embodiments of the invention and should not be taken as limiting the invention with regard to alternative embodiments that are not explicitly described herein.

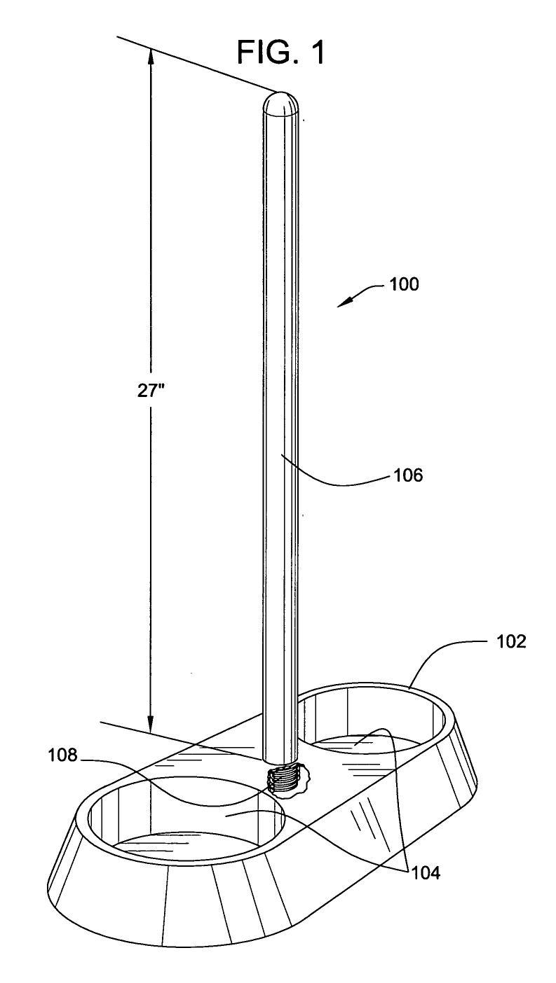

FIG. 1 shows an embodiment of a pet-food dish 100 according to the present invention. The pet-food dish 100 includes a plastic or metal base 102. The base 102 can be in accordance with any type of known handle-less pet-food dish. In FIG. 1, the base 102 includes two cavities 104 that dispense food or water to one or more pets. A vertical handle 106, typically formed of plastic, metal, or wood, is attached to the base 102 via an attachment mechanism 108. In FIG. 1, the handle 106 is 27 inches long. Different lengths can be used for different situations.

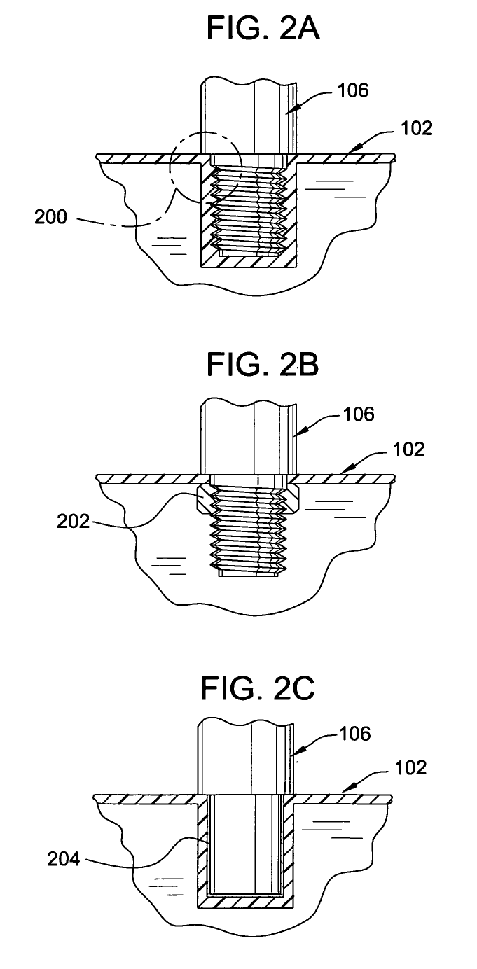

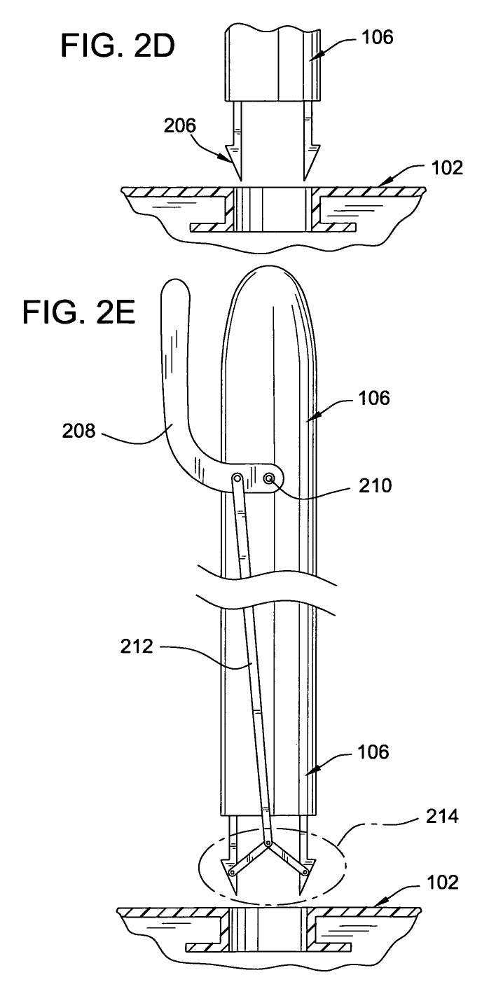

Numerous mechanisms well known in other areas of technology can be used to attach the handle 106 to the base 102. In FIG. 2a, the mechanism is a threaded receiver 200 in the base 102 into which the handle 106 screws. In FIG. 2b, a separate nut 202 screws onto the end of the handle 106 to hold it in place. FIG. 2c shows the handle 106 attached to the base 102 with glue 204. In the embodiment of FIG. 2d, the handle 106 includes a snap-lock 206 that holds the handle 106 in place once it is pressed into the base 102. Of these illustrated attachment mechanisms, the one of FIG. 2a can be made to be easily reversible, allowing the handle 106 to be attached for use and then detached when storing the pet-food dish 100 or when cleaning the base 102, in a dishwasher for example. Another reversible attachment mechanism is illustrated in FIG. 2e. When a user clasps a lever 208 against the handle 106, the lever pivots (at 210) and pulls on a rod 212 located within the handle 106. In turn, the rod 212 pulls on a reversible snap-lock 214 and thus disconnects the handle 106 from the base 102.

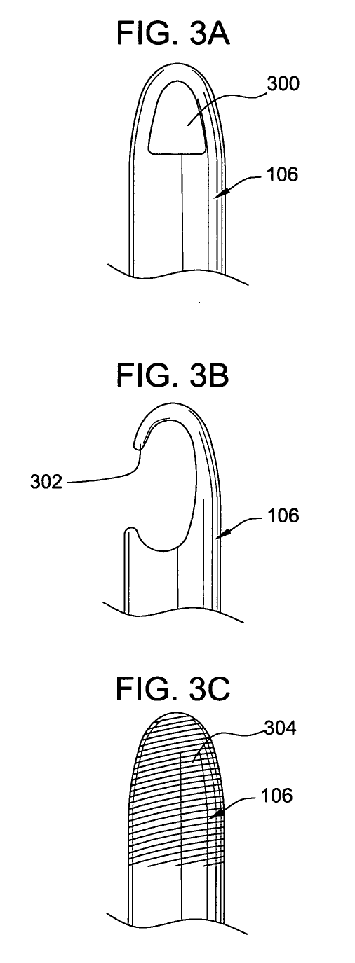

A few alternatives for the grasping end of the handle 106 are shown in FIGS. 3a through 3c. FIG. 3a shows a simple hole 300 through which one or more fingers are placed to lift the handle 106. In FIG. 3b, the hole is replaced by a “hook” 302. This hook 302 accommodates a finger and can be made large enough to fit much of a human hand for those users with reduced dexterity in their fingers. FIG. 3c shows a simple grasping end of the handle 106, here shown with a slip-resistant surface 304. The slip-resistant surface 304 is formed by covering the grasping end of the handle 106 with a substance such as rubber or by cutting or otherwise forming the grasping end to provide ridges or other surface irregularities.

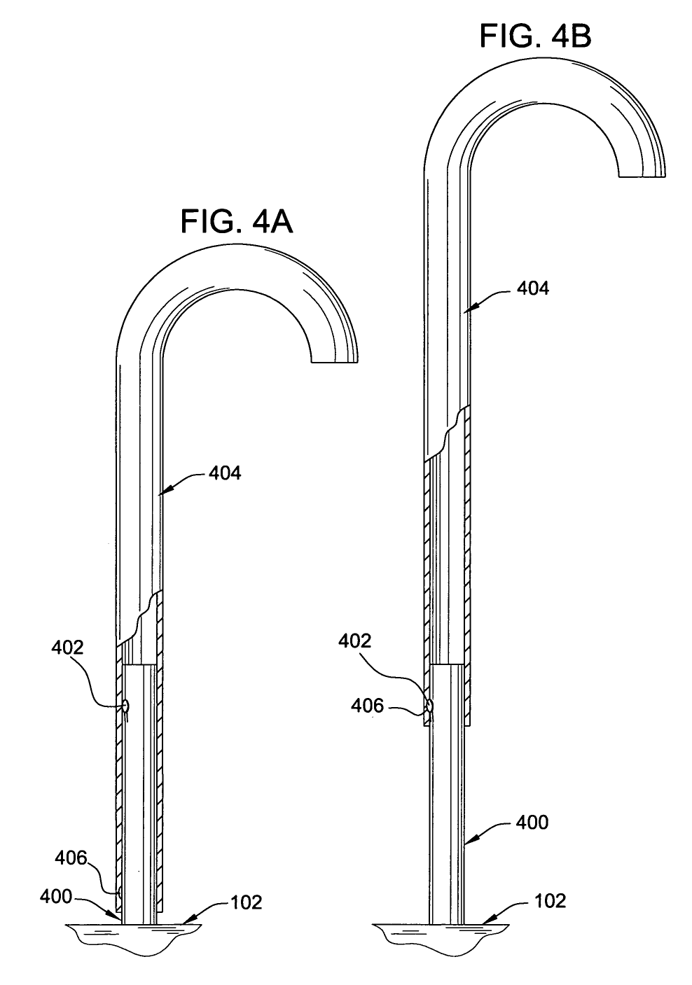

The handle 106 can be made to telescope to provide for adjustable height and for easier storage of the pet-food dish 100. For example, FIG. 4a shows a telescoping handle in its closed position. A lower portion of the handle 400 attaches to the base 102 of the pet-food dish 100. This lower portion 400 includes a release button 402. When the upper portion of the handle 404 is drawn up, the release button 402 engages with an aperture 406, thus locking the handle in its open position (see FIG. 4b). To collapse the handle, the release button 402 is pressed and the upper portion of the handle 404 slides down over the lower portion of the handle 400.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details, such as the materials used in construction, are determined by specific situations. Therefore, the invention as described herein contemplates all such embodiments as may come within the scope of the following claims and equivalents thereof.

We claim:

1. A pet-food dish with a handle, the pet-food dish comprising:
a base for dispensing pet food; and
a handle attached to the base.

2. The pet-food dish of claim 1 wherein the handle is attached to the base by a mechanism selected from the group consisting of: a threaded insert, a threaded nut, glue, a pressure-fit, a heat-melt mechanism, and a snap lock.

3. The pet-food dish of claim 1 wherein the handle is detachably attached to the base.

4. The pet-food dish of claim 3 further comprising a release mechanism for detachably attaching the handle to the base.

5. The pet-food dish of claim 4 wherein the release mechanism comprises:
a lever;
a linkage connecting the lever to a latch; and
the latch for attaching the handle to the base.

6. The pet-food dish of claim 1 wherein the handle telescopes in length.

7. The pet-food dish of claim 1 wherein the handle comprises a grasping end, and wherein the grasping end comprises a configuration selected from the group consisting of: a hole, a hook, a roughened surface, and an unfeatured surface.

8. The pet-food dish of claim 7 wherein the grasping end comprises a slip-resistant surface.

9. A base for a pet-food dish, the base comprising:
a cavity for dispensing pet food; and
an attachment mechanism for a handle.

10. The base for a pet-food dish of claim 9 wherein the attachment mechanism is selected from the group consisting of: a threaded insert, a threaded nut, glue, a pressure-fit, a heat-melt mechanism, and a spring lock.

11. The base for a pet-food dish of claim 9 wherein the attachment mechanism detachably attaches the handle to the base.
